(19) United States
(12) Patent Application Publication
(10) Pub. No.: US 2025/0285290 A1
(43) Pub. Date: Sep. 11, 2025

(54) OBJECT TRACKING FOR EXTENDED REALITY (XR) APPLICATIONS

(71) Applicant: Varjo Technologies Oy, Helsinki (FI)

(72) Inventors: Roman Golovanov, Helsinki (FI); Oleksandr Dovzhenko, Espoo (FI)

(73) Assignee: Varjo Technologies Oy, Helsinki (FI)

(21) Appl. No.: 18/596,786

(22) Filed: Mar. 6, 2024

(51) Int. Cl. G06T 7/20; G06T 7/70; G06T 17/00; G06V 10/25; G06V 10/44; G06V 40/20

(52) U.S. Cl. CPC G06T 7/20; G06T 7/70; G06T 17/00; G06V 10/25; G06V 10/44; G06V 40/28

(57) ABSTRACT

An Extended Reality (XR) device and a method for tracking an object for XR applications includes an imaging module configured to capture image data of an environment containing the object. The XR device also includes a processor configured to analyze the image data using a machine learning algorithm to estimate a pose of the object, generating pose estimation data; obtain inertial data corresponding to movements and/or orientations of the object from an Inertial Measurement Unit (IMU) affixed to the object; fuse the pose estimation data and the inertial data to generate combined tracking data for the object; and render one or more of position, movement, and orientation of the object within the XR application based on the combined tracking data. The XR device further includes a display module for projecting the rendered position, movement, and orientation of the object.

### TECHNICAL FIELD

The present disclosure relates to an Extended Reality (XR) device adapted for tracking an object for XR applications. Moreover, the present disclosure relates to a method for tracking an object for XR applications.

### BACKGROUND

In Extended Reality (XR) applications, which includes both Virtual Reality (VR) and Mixed Reality (MR), accurate tracking of objects and user inputs plays an important role in enhancing user experiences. Current XR tracking technologies range include optical systems employing markers and cameras, inertial measurement units (IMUs) that detect motion through accelerometers and gyroscopes, etc. These advancements have contributed to the immersion and interactivity achievable in XR applications. However, the current tracking technologies face substantial challenges, particularly in environments where conventional external tracking systems are constrained or impractical. This limitation is notably evident in scenarios involving Head-Mounted Display (HMD).

Conventionally, object tracking in XR HMDs has been facilitated through a range of approaches. Some systems utilize optical markers attached to objects for tracking, while more advanced systems employ dedicated tracking devices which interface with respective platforms. Alternative methods involved third-party tracking systems, providing tracking capabilities beyond the HMDs themselves. Still, the reliance on visual markers, while effective in certain contexts, has proven insufficient for dynamic object tracking, particularly in applications requiring virtual overlay of objects onto the physical environment.

Furthermore, use of handheld controller tracking within XR has also faced its own set of complications. Traditional methods primarily rely on visual features, such as tracking rings equipped with IR or visible LEDs, to facilitate computer vision-based tracking. This approach requires additional hardware components, including LED drivers and sophisticated optics, and further advanced software to synchronize LEDs with camera exposure. Such complexity not only increase the manufacturing costs and complicates the design, but also impact the battery life of wireless controllers. Moreover, tracking accuracy can be compromised in environments with variable lighting conditions or when the line of sight is obstructed, leading to interrupted or inaccurate tracking. The overall user experience is significantly affected by these limitations.

Therefore, in the light of the foregoing discussion, there exists a need to overcome the aforementioned drawbacks.

### SUMMARY

The aim of the present disclosure is to provide a method and an Extended Reality (XR) device for tracking objects and user interactions within XR applications, addressing the inherent limitations associated with traditional tracking methods. The aim of the present disclosure is achieved by a method and an XR device for tracking an object for XR applications, as defined in the appended independent claims, that leverage machine learning algorithms and inertial data from an Inertial Measurement Unit (IMU) affixed to the object or controller. This approach enables the accurate estimation of a pose of an object and integrates additional hand-tracking data, enhancing interaction fidelity and user immersion in XR environments without the need for external tracking systems or visual markers, thus simplifying hardware requirements and broadening application potential. Advantageous features and additional implementations are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is an illustration of schematic block diagram of an Extended Reality (XR) device adapted for tracking an object for XR applications, in accordance with embodiments of the present disclosure;

FIGS. 2A and 2B are illustrations of implementation of the XR device with handheld controllers as the object, in accordance with embodiments of the present disclosure; and

FIG. 3 is an illustration of a flowchart listing steps of a method for tracking an object for Extended Reality (XR) applications, in accordance with embodiments of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides an Extended Reality (XR) device adapted for tracking an object for XR applications, the XR device comprising:
an imaging module configured to capture image data of an environment containing the object;
a processor configured to:
   analyze the image data using a machine learning algorithm to estimate a pose of the object, generating pose estimation data;
   obtain inertial data corresponding to movements and/or orientations of the object from an Inertial Measurement Unit (IMU) affixed to the object;
   fuse the pose estimation data and the inertial data to generate combined tracking data for the object; and
   render one or more of position, movement, and orientation of the object within the XR application based on the combined tracking data; and
a display module for projecting the rendered position, movement, and orientation of the object.

In a second aspect, the present disclosure provides a method for tracking an object for Extended Reality (XR) applications, the method comprising:
capturing image data of an environment containing the object;
analyzing the image data using a machine learning algorithm to estimate a pose of the object, generating pose estimation data;
obtaining inertial data corresponding to movements and/or orientations of the object from an Inertial Measurement Unit (IMU) affixed to the object;
fusing the pose estimation data and the inertial data to generate a combined tracking data for the object; and
rendering one or more of position, movement and orientation of the object within the XR application based on the combined tracking data for the object.

The present disclosure provides the aforementioned XR device and the method for tracking an object for XR applications. The present disclosure leverages the integration of machine learning (ML) algorithms and inertial measurement data. The present disclosure utilizes ML for generating the pose estimation data for the object in conjunction with the IMU associated with the object to obtain the inertial data, and fuses the pose estimation data with the inertial data for rendering of the object within the XR application. The present disclosure eliminates the need for external tracking setups and visual markers, thereby simplifying the hardware design, reducing production costs, and extending the battery life of the XR system.

As used herein, the XR device refers to a hardware system designed to support XR applications. The XR device may integrate various technologies, including display, processing, sensing, and input mechanisms, to create immersive virtual or augmented environments where physical and digital objects co-exist and interact in real time. The XR applications, in turn, refer to software programs developed for the XR devices, including a wide range of uses from gaming and entertainment to training simulations and educational tools. These applications leverage the immersive capabilities of XR devices to provide users with experiences that blend virtual content with the real world.

The XR device of the present disclosure addresses the challenges associated with tracking objects and controllers in XR applications, offering a solution that integrates ML algorithms with inertial measurement data to enhance accuracy and user experience while simplifying the hardware requirements. In the XR applications, an “object” may refer to any item or entity that is tracked and/or interacted with in the virtual or augmented environment. This includes virtual representations of real-world items, such as controllers, as well as purely digital entities created within the XR space.

The XR device includes the imaging module configured to capture image data of an environment containing the object. Herein, the “environment” containing the object may refer to a physical surrounding space within which the XR application operates, including both the real-world setting and virtual elements introduced by the XR system. The imaging module is a component of the XR device which may include cameras and/or sensors, to capture visual representations of the surrounding space, transforming them into digital image data. The image data is a digital representation of the visual aspects of the environment, captured by the imaging module, which allows for analyzing and tracking objects within the XR application. The captured image data is utilized for subsequent processing steps for overall effectiveness of the system in tracking objects within XR applications, to provide an efficient integration of virtual and real-world elements.

In an embodiment, the imaging module employs multiple cameras for capturing the image data. The use of multiple cameras within the imaging module allows for the simultaneous capture of image data from different vantage points. Each camera is positioned to provide a unique view of the environment, with their collective coverage designed to cover the full spatial extent of possible movements and orientations of the object. This arrangement is particularly beneficial for overcoming common tracking challenges such as occlusions and limited field of view, which can limit the accuracy and reliability of single-camera systems. The image data captured by the multiple cameras may be synchronized and aligned to be effectively analyzed for extraction of coherent spatial information about the object.

The XR device includes the processor to perform the processing tasks. In the XR device, the processor may include hardware, software, firmware, or a combination thereof, which may be specifically designed and optimized for data processing tasks within the XR device. The processor is responsible for orchestrating the operation of the XR device, particularly in the context of object tracking within XR applications. In general, the processor serves as the central computing core of the XR device, interfacing with various components to facilitate comprehensive tracking and rendering functionalities.

The processor is configured to analyze the image data using the machine learning algorithm to estimate the pose of the object, generating the pose estimation data. In the context of the present disclosure, particularly within the scope of XR applications, the term “pose estimation” refers to the computational process of determining the position and orientation of the object within the given environment. This process involves analyzing visual, inertial, or other forms of sensory data to determine the spatial attributes of the object, including its location, rotation, and movement within the three-dimensional space of the XR environment. The pose estimation data generated through this process is a representation of spatial state of the object, providing its position (x, y, z coordinates in the environment) and orientation (angles or rotations around the x, y, and z axes). In the XR device, the processor is configured to process the image data in near real-time for maintaining the responsiveness of the XR application.

In an embodiment, the machine learning algorithm utilizes a convolutional neural network and/or pooling operations to analyze pixel intensities in the image data and extract feature vectors from the image data, for estimating the pose of the object. That is, the machine learning algorithm, as used herein, often leverage convolutional neural networks (CNNs) which are adapted for interpreting complex visual patterns, identifying objects, and determining their spatial orientation based on the trained models. The CNN is a class of deep neural networks, highly effective in analyzing visual imagery. The CNN is composed of multiple layers, including convolutional layers that apply various filters to the input image to create feature maps. In an example implementation, the machine learning algorithm is a regression Convolutional Neural Network (CNN), which processes the captured image data, identifying and estimating the pose of objects within the environment.

The pooling operations, which may be included in the CNN architecture, may reduce the spatial dimensions of the feature maps generated by the convolutional layers. The most common form of pooling is max pooling, where the maximum value from each cluster of neurons in the feature map is retained, and the rest are discarded. Such operation reduces the computational load on the system by reducing the size of the data being processed. Such architecture of the algorithm allows for the extraction of detailed feature vectors from the pixel data, enabling the precise localization of hand landmarks and other relevant object features. The ability of the CNN to identify these points in real-time enables accurate pose estimations, to allow for subsequent tracking and interaction mechanisms within the XR application.

In an embodiment, the processor is further configured to segment the image data to define region of interest containing the object in the environment, for analysis and feature extraction by the machine learning algorithm. The segmentation process involves selectively identifying and delineating regions of interest (ROIs) within the captured image data that contain the object to be tracked. This process may utilize edge detection algorithms, color thresholding, pattern recognition, or a combination of these and other techniques to accurately outline the regions where the object appears. Once the ROIs containing the object are defined, the processor directs the machine learning algorithm to focus its analysis and feature extraction efforts on these segments. That is, the segmentation process is aimed at focusing the subsequent analysis and feature extraction processes on these specific areas, thereby optimizing the computational resources of the processor and improving overall performance of the XR device.

The processor is further configured to obtain the inertial data corresponding to movements and/or orientations of the object from the Inertial Measurement Unit (IMU) affixed to the object. The XR device employs the IMU, which may include sensors, such as accelerometers and gyroscopes, and optionally magnetometers, that collectively gather inertial data. The function of the IMU is to continuously monitor the forces and rotational rates experienced by the object to which it is associated. In XR applications, the IMU may be integrated into various objects, including handheld controllers, wearable devices, or any other items that require tracking within the virtual environment. It may be understood that the term “affixed to the object,” within this context, includes a broad range of techniques for associating the IMU with the object being tracked. This does not necessarily imply a physical attachment, and include other means of securement that ensure the IMU remains in a consistent positional and orientational relationship with the object during tracking.

In the XR device, the processor maintains a communicative link with the IMU affixed to the tracked object to acquire inertial data, including information about movements and orientations of the object. The inertial data includes acceleration and rotational velocities of the object's dynamics independent of the visual cues captured by the imaging module. In particular, the inertial data includes measurements of linear acceleration along three perpendicular axes (x, y, and z) and rotational rates around these axes. It may be appreciated that the inertial data from the IMU is typically high frequency data, as compared to the pose estimation data as captured from the imaging module. The inertial data may be particularly valuable in scenarios where visual tracking may be compromised, such as in occluded or highly dynamic environments, ensuring that the XR device is able to infer spatial dynamics of the object even in such conditions.

The processor is further configured to fuse the pose estimation data and the inertial data to generate combined tracking data for the object. That is, the processor fuses the pose estimation data, derived from analyzing image data, with the inertial data obtained from the IMU affixed to the tracked object. Herein, the pose estimation data represents position and orientation of the object based on images captured by the imaging module. This data helps in understanding the object's location within the environment but may be susceptible to inaccuracies due to occlusions, variable lighting conditions, or the limitations of visual recognition algorithms. On the other hand, the inertial data from the IMU provides high-frequency details about movements and changes in orientation of the object, independent of visual factors. This fusion process leverages the strengths of both data types, using the high-frequency inertial data to refine and enhance the pose estimation derived from the image data, resulting in highly accurate and reliable tracking information.

More specifically, in the present examples, the pose estimation data, derived from analyzing image data captured by the imaging module, provides detailed insights into spatial orientation and position of the object within the environment. This data is obtained using advanced machine learning algorithms, including Convolutional Neural Networks (CNNs), which are configured for interpreting complex visual information to determine the object's pose. Concurrently, the inertial data is obtained from the IMU associated with the object, providing measurements of movements and orientations of the object. This data includes high-frequency information about accelerations and rotational velocities of the object, providing a dynamic view of its motion. The process of fusing these two data types involves sophisticated algorithms that combine the detailed spatial insights from the pose estimation data with the dynamic motion information from the inertial data. This fusion results in the combined tracking data that provides a comprehensive view of position, movement, and orientation of the object, enhancing overall accuracy and reliability of the XR device.

The processor may utilize sophisticated algorithms that integrate the pose estimation data and the inertial data. This fusion process may employ techniques such as sensor fusion algorithms, Extended Kalman Filters (EKF), or other advanced filtering and data integration methodologies. By generating the combined tracking data, the processor ensures that the XR system maintains a high degree of tracking fidelity, even in scenarios where either the visual or inertial data alone may be compromised. This integrated approach enables the XR device to provide an immersive experience, based on accurate representation of position, movement, and orientation of the object within the virtual environment, ensuring that virtual interactions align closely with the user's physical actions.

In some examples, the design and implementation of the XR device consider the proprietary hand tracking solutions and use MediaPipe CNN for stable hand tracking results, even when an object is held in the hand. The tests showed promising results in identifying Regions of Interest (ROI) with the hand and key points on the palm, indicating capability to accurately track hand movements and interactions with objects. Moreover, in some implementations, the XR device utilizes multimodal machine learning approaches for data fusion. These approaches include the machine learning model itself managing the integration of diverse data types, such as camera frames and IMU data, without relying on traditional pipeline designs. This solution provides a more integrated and automated approach to data fusion, to enhance efficiency and adaptability of the XR device.

In an embodiment, the object is a handheld controller for use with the XR device, and wherein the XR device further comprises a proximity sensor configured to detect the presence of a user's hand relative to the handheld controller, and wherein the processor is further configured to:
determine an initial position of the handheld controller based on the combined tracking data therefor; and
utilizing the initial position as a reference point for subsequent tracking of the handheld controller.

Herein, the handheld controller is a component for user interaction in the XR device, and is designed as the primary interface through which the user interacts with the virtual environment within the XR applications. The handheld controller may include various input mechanisms and sensors, including the IMU, to facilitate accurate tracking of its position and orientation. In particular, the handheld controller has the proximity sensor integrated within or in close association therewith. The proximity sensor is configured to detect the presence and proximity of the user's hand relative to the handheld controller. Thereby, the proximity sensor enables the XR device to determine when the handheld controller is being actively held by the user. This allows the processor to determine when to initiate the tracking process, ensuring that tracking resources are efficiently allocated for accurate monitoring of the controller during use.

Upon detection of the user's hand by the proximity sensor, the processor determines the initial position of the handheld controller. The initial position provides reference point for location of the handheld controller within the XR environment. This determination is based on the combined tracking data, which includes both the pose estimation data derived from the imaging module and the inertial data from the IMU associated with the handheld controller. The initial position of the handheld controller, once established, is utilized by the processor as a reference point for all subsequent tracking activities. This reference point allows the XR device to accurately monitor movements and changes in orientation of the handheld controller relative to its initial position. The processor continuously updates the tracking data to determine current state of the handheld controller, comparing it against the initial position to understand the user's interactions and inputs within the virtual environment.

Optionally, the proximity sensor employs one or more of capacitive sensing, infrared sensing, or ultrasonic sensing techniques to detect the presence of the user's hand relative to the handheld controller. Each one of these sensing techniques provides unique advantages for different interaction scenarios within the XR environment. For instance, the capacitive sensing relies on the electrical properties of the human body to detect the presence of the user's hand. This technique involves measuring changes in capacitance when a conductive object, such as a human hand, comes into close proximity to the sensor. Capacitive sensing is particularly effective for close-range interactions, providing high sensitivity and the ability to detect gestures and hand positioning even without direct contact. Infrared (IR) sensing employs IR light to detect the user's hand by emitting IR signals and measuring the reflection or interruption of these signals when an object, such as a hand, is nearby. IR sensing is advantageous for its ability to operate in a variety of lighting conditions and its non-intrusive nature. Ultrasonic sensing utilizes high-frequency sound waves to detect objects in the its vicinity. Ultrasonic sensing is characterized by its long-range detection capabilities and its effectiveness in environments where optical sensors may be limited by ambient light or visual obstructions.

In an embodiment, the handheld controller has a predetermined shape and a predetermined button configuration, and wherein the processor is further configured to:
correlate one or more of the predetermined shape and the predetermined button configuration of the handheld controller with detected finger positions of the user's hand thereon, generating hand position data; and
integrate the hand position data with the combined tracking data, for implementation in tracking of the object.

Generally, the shape of the handheld controller is designed to fit naturally in the user's hand, while the placement and layout of the buttons are configured to be easily accessible within the XR environment. The processor analyzes the hand position data, which may be derived from additional sensors or imaging techniques capable of capturing the user's hand movements and gestures. By understanding how the user's fingers align with the buttons of the handheld controller, the processor generates the hand position data representative of the user's interaction patterns. The hand position data generated through this correlation process includes information about which buttons are being pressed and the orientation of the hand relative to the handheld controller, which, in turn, helps in interpreting the user's inputs and translating them into corresponding actions within the XR application.

The processor further integrates the hand position data with the combined tracking data for the handheld controller, which includes the pose estimation data and the inertial data. Such integrated combined tracking data provides a comprehensive understanding of the spatial state of the handheld controller and the user's specific interactions therewith. Thereby, the integration of the hand position data and the combined tracking data allows the XR device to track the handheld controller with increased accuracy, ensuring that the virtual representations of the user's actions are aligned with their real-world movements and inputs.

In an embodiment, the imaging module is further configured to capture additional image data related to a user's hand, and wherein the processor is configured to:
analyze the additional image data, using a hand-tracking algorithm, to determine a position and/or an orientation of the user's hand, generating hand tracking data; and
integrate the hand tracking data with the combined tracking data, for implementation in tracking of the object.

The imaging module is configured to capture a wide range of visual data within the XR environment, including images of the user's hand. This capability is important for applications where hand gestures and movements are integral to the user interface, such as in gesture-based controls or when interacting with virtual objects. The additional image data related to the user's hand provides information that can be analyzed to understand the user's intent and actions. Upon capturing the additional image data, the processor employs the hand-tracking algorithm to analyze this information and extract insights about the user hand's position and orientation. The hand-tracking algorithm is implemented as part of the machine learning framework within the XR device, to identify key features of the hand, such as fingertips, joints, and palm orientation. By processing the visual data related to the hand, the hand-tracking algorithm can determine the user hand's spatial configuration and movements.

The processor further integrates the hand tracking data with the combined tracking data derived from the object tracking process. Such integrated combined tracking data includes pose estimations of the object, such as the handheld controller, as well as the inertial data from the IMU affixed to the object. By integrating the hand tracking data with the combined tracking data, the processor enhances the overall tracking system, allowing for synchronized tracking of both the object and the user's hand. This enables the XR device to not only track the position and orientation of objects within the environment, such as a handheld controller, but also to monitor and interpret the user's hand movements and gestures in real-time. This capability is particularly useful in scenarios where the user's hand interacts directly with the object, such as in manipulating virtual controls, performing gestures to trigger actions, or in applications that simulate direct hand-object contact.

The processor is further configured to render one or more of position, movement, and orientation of the object within the XR application based on the combined tracking data. Herein, the combined tracking data, including the pose estimation data and the inertial data, and in some cases, also the hand position data and the hand tracking data, is utilized to determine the precise position of the object within the virtual environment, including its movement trajectory, and its orientation at any given moment. The rendering process visualizes the spatial attributes of the object in real-time, allowing users to interact with the object. The rendering of position ensures that the object appears in the correct location within the virtual space, while the rendering of movement captures trajectory and speed of the object, providing a dynamic representation that responds to real-world motions of the object. By rendering the object's position, movement, and orientation based on the combined tracking data, the processor ensures that the virtual representation of the object within the XR application is accurately aligned with the real-world, providing users with an immersive experience.

The XR device further includes a display module for projecting the rendered position, movement, and orientation of the object. The display module acts as the interface through which the virtual representations of the object are visually communicated to the user. The display module is communicatively disposed with other components of the XR device, particularly the processor. The display module operates by receiving the processed tracking data which has been rendered by the processor, to represent spatial attributes of the object in the virtual environment. Upon receiving the rendered data, the display module projects it onto output interface of the XR device, which may include a screen in the case of Virtual Reality (VR) or a transparent display for Mixed Reality (MR) applications. This projection involves translating the digital representations of position, movement, and orientation of the object into visual formats that are perceivable by the user. By ensuring that the virtual representations of objects align with the user's physical interactions and expectations, the display module enhances user engagement and interaction.

The present disclosure also relates to the second aspect as described above. Various embodiments and variants disclosed above, with respect to the aforementioned first aspect apply mutatis mutandis to the second aspect.

The method for tracking the object in the XR applications includes a series of steps designed to determine the spatial attributes of the object within a virtual or augmented environment. This method integrates various technologies and data sources to provide a dynamic tracking solution for immersive XR experiences. The method involves capturing image data of the environment that contains the object to be tracked. This process is facilitated by the imaging module of the XR device, which may comprise one or more cameras strategically positioned to cover a wide field of view. The captured image data provides a visual representation of the environment, including the object, to allow for subsequent analysis. Upon capturing the image data, the method proceeds to analyze this data using the machine learning algorithm to estimate the pose of the object. The pose estimation involves determining position and orientation of the object within the environment for accurate tracking. Concurrently, the method involves obtaining the inertial data that corresponds to the movements and/or orientations of the object from the IMU affixed to the object, providing high-frequency measurements of accelerations and rotational velocities of the object. The method, then, involves fusing of the pose estimation data derived from the image analysis with the inertial data obtained from the IMU. This data fusion process leverages advanced algorithms to integrate the two data types, using the inertial data to refine and enhance the pose estimations, generating the combined tracking data that provides a more accurate representation of spatial state of the object. The method, then, involves rendering position, movement, and orientation of the object within the XR application based on the combined tracking data, allowing users to interact with the object intuitively within the XR environment.

In an embodiment, the object is a handheld controller for use in the XR applications, and the method further comprises:
detecting a presence of a user's hand in proximity to the handheld controller;
determining an initial position of the handheld controller based on the combined tracking data therefor; and
utilizing the initial position as a reference point for subsequent tracking of the handheld controller.

Herein, the method includes detecting the presence of a user's hand in proximity to the handheld controller. This detection is facilitated by the proximity sensor integrated into the handheld controller, employing technologies such as capacitive, infrared, or ultrasonic sensing. The ability to determine proximity of the user's hand allows for initiating the tracking process, ensuring that movements of the handheld controller are monitored and interpreted only when it is actively being used, thereby enhancing efficiency and responsiveness of the present method.

In an embodiment, the method further comprises:
correlating one or more of a predetermined shape and a predetermined button configuration of the handheld controller with detected finger positions of the user's hand thereon, generating hand position data; and
integrating the hand position data with the combined tracking data, for implementation in tracking of the object.

Herein, the method includes a process of correlating predetermined shape and button configuration of the handheld controller with the detected positions of the user's fingers. This correlation involves analyzing the interaction between the user's hand and the handheld controller to generate the hand position data, which provides details about how the user is holding and operating the handheld controller. By understanding these interactions, the present method may provide more intuitive control schemes and improve the accuracy of input recognition, enhancing the user's experience within the XR environment.

In an embodiment, the method further comprises:
capturing additional image data related to a user's hand;
analyzing the additional image data, using a hand-tracking algorithm, to determine a position and/or an orientation of the user's hand, generating hand tracking data; and
integrating the hand tracking data with the combined tracking data, for implementation in tracking of the object.

Herein, the method includes capturing the additional image data specifically related to the user's hand. This may be implemented for applications that rely on gesture-based interactions or require detailed tracking of hand movements. The imaging module of the XR device is configured to capture this data, which is then analyzed using the hand-tracking algorithm for determining the position and orientation of the user's hand to generate the hand tracking data that is rich in detail. By integrating this hand tracking data with the combined tracking data for the handheld controller, the present method allows for more precise control within the XR environment.

In an embodiment, the method further comprises segmenting the image data to define region of interest containing the object in the environment, for analysis and feature extraction by the machine learning algorithm.

This segmentation process helps in focusing the analysis on specific parts of the environment where the object is located, thereby enhancing the efficiency and accuracy of the subsequent machine learning analysis. By isolating these ROIs, the machine learning algorithm can direct its computational resources towards extracting relevant features from areas within the image data containing details about the object's pose, and thereby improving overall performance.

In an embodiment, the machine learning algorithm utilizes a convolutional neural network and/or pooling operations to analyze pixel intensities in the image data and extract feature vectors from the image data, for estimating the pose of the object.

The method employs the convolutional neural network (CNN), possibly in conjunction with pooling operations, to analyze the pixel intensities within the segmented regions of interest. CNNs are particularly configured for parsing image data, using multiple layers of convolutional filters to detect patterns, edges, and textures that are indicative of the position and orientation of the object. The inclusion of pooling operations further refines the process by downsampling the feature maps generated by the convolutional layers, reducing the computational load while retaining spatial information. Thus, the present method is able to efficiently extract high-level feature vectors from the image data, for accurately estimating the object's pose within the XR environment.

In an embodiment, the method further comprises projecting the rendered position, movement, and orientation of the object onto a display of an XR device.

This projection translates the tracking data into visual representations that are integrated into the virtual scene, allowing users to perceive and interact with the object as if it were a part of the XR environment. The display renders these spatial attributes in near real-time for providing immersive XR experience.

The XR device and the method of the present disclosure provide significant advantages over known techniques in the field of XR tracking. By utilizing the machine learning algorithms for processing inertial data, the system achieves a high level of tracking accuracy even against environmental variations and occlusions, which have traditionally posed challenges for XR tracking systems. The XR device and the method of the present disclosure also simplifies the hardware requirements for XR controllers by eliminating the need for external visual markers or LEDs, thereby reducing production costs and extending battery life. Further, the ability to accurately track both the handheld controller and the user's hand interactions in real-time enhances the immersive experience of XR applications, making interactions more natural and intuitive.

### DETAILED DESCRIPTION OF THE DRAWINGS

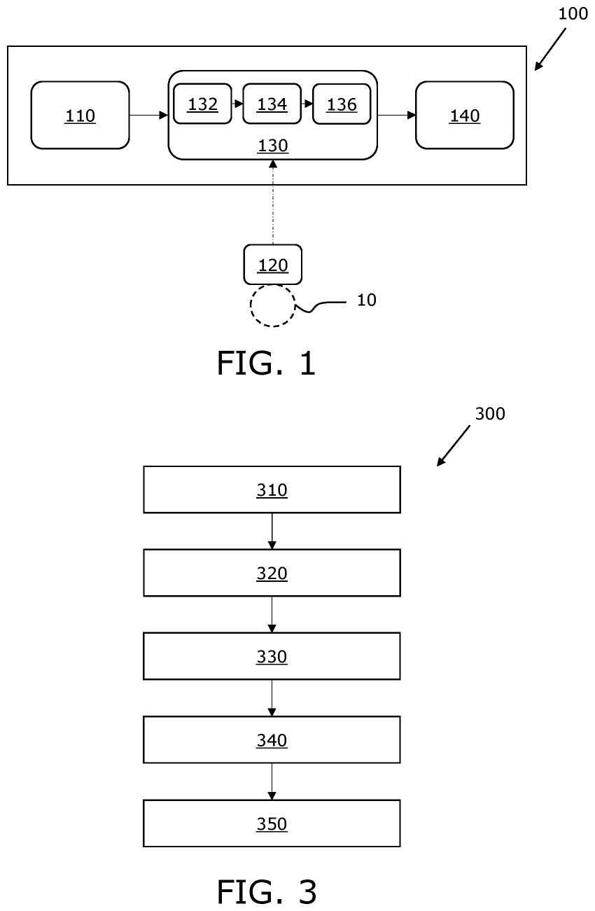

Referring to FIG. 1, illustrated is a schematic block diagram of an Extended Reality (XR) device 100 adapted for tracking an object 10 for XR applications, in accordance with embodiments of the present disclosure. The XR device 100 includes an imaging module 110 configured to capture image data of an environment containing the object 10. The XR device 100 also includes an Inertial Measurement Unit (IMU) 120 affixed to the object 10, to inertial data corresponding to movements and/or orientations of the object 10. The XR device 100 further includes a processor 130, comprising a machine learning algorithm module 132, a fusion module 134 and a rendering module 136. The processor 130, via the machine learning algorithm module 132, is configured to analyze the image data using a machine learning algorithm to estimate a pose of the object 10, generating pose estimation data. The processor 130 is also configured to obtain the inertial data corresponding to movements and/or orientations of the object 10 from the IMU 120 affixed to the object 10. The processor 130, via the fusion module 134, is further configured to fuse the pose estimation data and the inertial data to generate combined tracking data for the object 10. The processor 130, via the rendering module 136, is further configured to render one or more of position, movement, and orientation of the object 10 within the XR application based on the combined tracking data. The XR device 100 further includes a display module 140 for projecting the rendered position, movement, and orientation of the object 10.

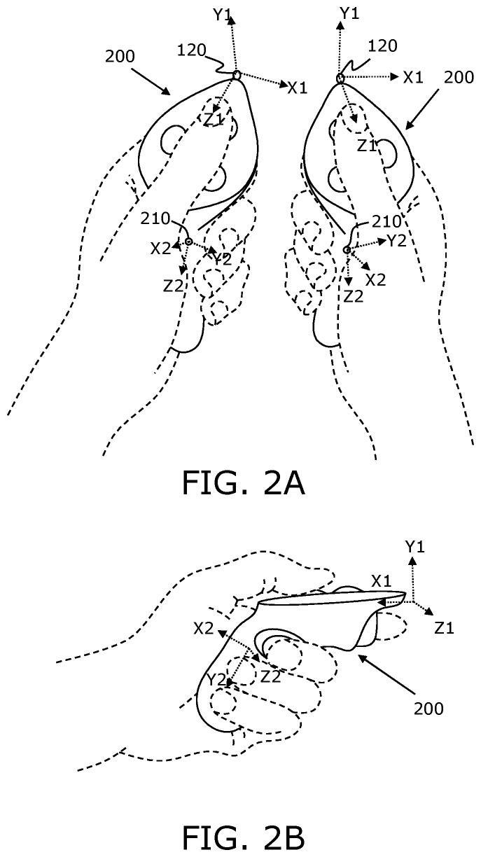

Referring to FIGS. 2A and 2B, illustrated are depictions of implementation of the XR device 100 with handheld controllers 200 as the object (i.e., the object 10 of FIG. 1), in accordance with embodiments of the present disclosure. Each handheld controllers 200 is shown with integrated Inertial Measurement Unit (IMUs) 120 to provide corresponding inertial data on movements and orientations, represented by axes X1, Y1, and Z1. Further, each handheld controller 200 includes a proximity sensor 210 for detecting presence and position of the user's hand, as well as estimate orientation of fingers and the palm, along axes X2, Y2, and Z2. This hand-tracking capability allows for interaction schemes within the XR application, such as gesture recognition and manipulation of virtual objects corresponding to the user's hand movements. The fusion of the inertial data of the handheld controllers 200 with hand poses enhance the precision of object tracking within the XR environment.

Referring to FIG. 3, illustrated is a flowchart listing steps involved in a method 300 for tracking an object for Extended Reality (XR) applications, in accordance with embodiments of the present disclosure. The method 300 is implemented by the XR device 100. At step 310, the method 300 includes capturing image data of an environment containing the object. At step 320, the method 300 includes analyzing the image data using a machine learning algorithm to estimate a pose of the object, generating pose estimation data. At step 330, the method 300 includes obtaining inertial data corresponding to movements and/or orientations of the object from an Inertial Measurement Unit (IMU) affixed to the object. At step 340, the method 300 includes fusing the pose estimation data and the inertial data to generate a combined tracking data for the object. At step 350, the method 300 includes rendering one or more of position, movement and orientation of the object within the XR application based on the combined tracking data for the object.

The aforementioned steps 310-350 are only illustrative, and other alternatives can also be provided where one or more steps are added, one or more steps are removed, or one or more steps are provided in a different sequence without departing from the scope of the claims herein.

1. An Extended Reality (XR) device adapted for tracking an object for XR applications, the XR device comprising:
an imaging module configured to capture image data of an environment containing the object;
a processor configured to:
analyze the image data using a machine learning algorithm to estimate a pose of the object, generating pose estimation data;
obtain inertial data corresponding to movements and/or orientations of the object from an Inertial Measurement Unit (IMU) affixed to the object;
fuse the pose estimation data and the inertial data to generate combined tracking data for the object; and
render one or more of position, movement, and orientation of the object within the XR application based on the combined tracking data; and
a display module for projecting the rendered position, movement, and orientation of the object.

2. The XR device of claim 1, wherein the object is a handheld controller for use with the XR device, and wherein the XR device further comprises a proximity sensor configured to detect the presence of a user's hand relative to the handheld controller, and wherein the processor is further configured to:
determine an initial position of the handheld controller based on the combined tracking data therefor; and
utilizing the initial position as a reference point for subsequent tracking of the handheld controller.

3. The XR device of claim 2, wherein the handheld controller has a predetermined shape and a predetermined button configuration, and wherein the processor is further configured to:
correlate one or more of the predetermined shape and the predetermined button configuration of the handheld controller with detected finger positions of the user's hand thereon, generating hand position data; and
integrate the hand position data with the combined tracking data, for implementation in tracking of the object.

4. The XR device of claim 1, wherein the imaging module is further configured to capture additional image data related to a user's hand, and wherein the processor is configured to:
analyze the additional image data, using a hand-tracking algorithm, to determine a position and/or an orientation of the user's hand, generating hand tracking data; and
integrate the hand tracking data with the combined tracking data, for implementation in tracking of the object.

5. The XR device of claim 1, wherein the processor is further configured to segment the image data to define region of interest containing the object in the environment, for analysis and feature extraction by the machine learning algorithm.

6. The XR device of claim 1, wherein the machine learning algorithm utilizes a convolutional neural network and/or pooling operations to analyze pixel intensities in the image data and extract feature vectors from the image data, for estimating the pose of the object.

7. The XR device of claim 2, wherein the proximity sensor employs one or more of capacitive sensing, infrared sensing, or ultrasonic sensing techniques to detect the presence of the user's hand relative to the handheld controller.

8. The XR device of claim 1, wherein the imaging module employs multiple cameras for capturing the image data.

9. A method for tracking an object for Extended Reality (XR) applications, the method comprising:
capturing image data of an environment containing the object;
analyzing the image data using a machine learning algorithm to estimate a pose of the object, generating pose estimation data;
obtaining inertial data corresponding to movements and/or orientations of the object from an Inertial Measurement Unit (IMU) affixed to the object;
fusing the pose estimation data and the inertial data to generate a combined tracking data for the object; and
rendering one or more of position, movement and orientation of the object within the XR application based on the combined tracking data for the object.

10. The method of claim 9, wherein the object is a handheld controller for use in the XR applications, and wherein the method further comprises:
detecting a presence of a user's hand in proximity to the handheld controller;
determining an initial position of the handheld controller based on the combined tracking data therefor; and
utilizing the initial position as a reference point for subsequent tracking of the handheld controller.

11. The method of claim 10 further comprising:
correlating one or more of a predetermined shape and a predetermined button configuration of the handheld controller with detected finger positions of the user's hand thereon, generating hand position data; and
integrating the hand position data with the combined tracking data, for implementation in tracking of the object.

12. The method of claim 9 further comprising:
capturing additional image data related to a user's hand;
analyzing the additional image data, using a hand-tracking algorithm, to determine a position and/or an orientation of the user's hand, generating hand tracking data; and
integrating the hand tracking data with the combined tracking data, for implementation in tracking of the object.

13. The method of claim 9 further comprising segmenting the image data to define region of interest containing the object in the environment, for analysis and feature extraction by the machine learning algorithm.

14. The method of claim 9, wherein the machine learning algorithm utilizes a convolutional neural network and/or pooling operations to analyze pixel intensities in the image data and extract feature vectors from the image data, for estimating the pose of the object.

15. The method of claim 9 further comprising projecting the rendered position, movement, and orientation of the object onto a display of an XR device.
